(19) United States
(12) Patent Application Publication
(10) Pub. No.: US 2023/0073147 A1
(43) Pub. Date: Mar. 9, 2023

(54) METHOD AND APPARATUS FOR PROVIDING HUMAN-MACHINE-INTERFACE MODE OF VEHICLE

(71) Applicants: HYUNDAI MOTOR COMPANY, Seoul (KR); Kia Corporation, Seoul (KR)

(72) Inventors: Jung Seok SUH, Yongin-si (KR); Ja Yoon GOO, Anyang-si (KR)

(73) Assignees: HYUNDAI MOTOR COMPANY, Seoul (KR); Kia Corporation, Seoul (KR)

(21) Appl. No.: 17/668,615

(22) Filed: Feb. 10, 2022

(30) Foreign Application Priority Data
Sep. 1, 2021 (KR) 10-2021-0116236

(51) Int. Cl. B60W 50/16; G06F 3/01; B60K 35/00; B60W 60/00

(52) U.S. Cl. CPC B60W 50/16; G06F 3/013; B60K 35/00; B60W 60/005; B60W 2050/146

(57) ABSTRACT

A method and apparatus for providing a human-machine interface (HMI) mode of a vehicle are provided. The method, performed by a device of vehicle, for providing a human-machine interface (HMI) mode includes, determining an occupant's state, determining an HMI mode corresponding to the occupant's state among a plurality of predefined HMI modes, and providing guidance information to the occupant in a medium-specific output scheme corresponding to the determined HMI mode.

### CROSS-REFERENCE TO RELATED APPLICATIONS

The present application is based on, and claims priority from, Korean Patent Application Number 10-2021-0116236, filed Sep. 1, 2021, the disclosures of which are incorporated by reference herein in their entireties.

### TECHNICAL FIELD

The present disclosure relates to a method and apparatus for providing a human-machine interface (HMI) mode of a vehicle and, more particularly, to a method and apparatus for varying the level of guidance provided by the HMI on the basis of an occupant's state.

### BACKGROUND

The statements in this section merely provide background information related to the present disclosure and may not constitute a related art.

Recently, research on autonomous driving has been actively conducted.

In autonomous vehicle technology, it is important for occupants to have confidence in autonomous vehicles. To this end, autonomous vehicles use a human-machine interface (HMI) to guide occupants on a current driving situation and actions to be taken in the future.

However, autonomous vehicles currently under development only provide guidance at a level preset by a manufacturer. Accordingly, when a guidance level provided by a vehicle is less detailed than a guidance level desired by an occupant, it is difficult for the occupant to build confidence in the autonomous vehicle. Conversely, if the guidance level provided by the vehicle is much more detailed than the desired guidance level, there is a problem in that the occupant may be distracted due to concentrating on other tasks (e.g., sleeping, talking, using a mobile phone, watching media, etc.).

### SUMMARY

The present disclosure provides a method and apparatus for ensuring an occupant's confidence in an autonomous vehicle without disturbing the occupant's concentration by providing a human-machine interface (HMI) mode suitable for a guidance level desired by the occupant.

According to at least one aspect, the present disclosure provides a method, performed by a device of vehicle, for providing a human-machine interface (HMI) mode including determining an occupant's state, determining an HMI mode corresponding to the occupant's state among a plurality of predefined HMI modes, and providing guidance information to the occupant in a medium-specific output scheme corresponding to the determined HMI mode.

According to another aspect, the present disclosure provides a device for providing a human-machine interface (HMI) mode including controller. The controller is configured to determine an occupant's state in a vehicle, determine an HMI mode corresponding to the occupant's state among a plurality of predefined HMI modes, and provide guidance information to the occupant in a medium-specific output scheme corresponding to the determined HMI mode.

According to yet another aspect, the present disclosure provides a vehicle including an HMI mode provision device. The HMI mode provision device is configured to determine an occupant's state in a vehicle, determine an HMI mode corresponding to the occupant's state among a plurality of predefined HMI modes, and provide guidance information to the occupant in a medium-specific output scheme corresponding to the determined HMI mode.

As described above, according to an embodiment of the present disclosure, by providing an HMI mode suitable for a guidance level desired by an occupant, it is possible to secure the occupant's confidence in an autonomous vehicle without disturbing the occupant's concentration.

### BRIEF DESCRIPTION OF THE DRAWINGS

FIG. 1 is a block diagram illustrating a related configuration for providing a human-machine interface (HMI) mode according to an exemplary embodiment of the present disclosure.

FIG. 2 is a diagram illustrating an example of an operation in which an HMI mode provision device determines an HMI mode on the basis of an occupant's state according to an exemplary embodiment of the present disclosure.

FIG. 3 is a flowchart illustrating an HMI mode provision method according to an exemplary embodiment of the present disclosure.

FIGS. 4 to 6 are flowcharts illustrating an example of a method of an HMI mode provision device providing an HMI mode to multiple occupants according to an exemplary embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

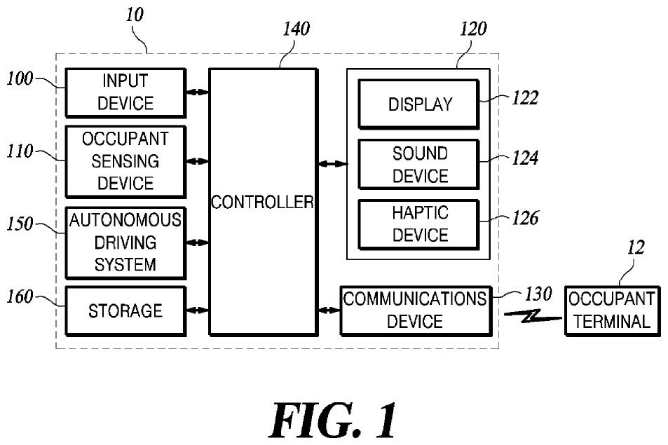

FIG. 1 is a block diagram illustrating a related configuration for providing a human-machine interface (HMI) mode according to an exemplary embodiment of the present disclosure.

A vehicle 10 may be configured to determine an HMI mode corresponding to an occupant's state among a plurality of predefined HMI modes and provide guidance information about the vehicle 10 to the occupant according to the determined HMI mode. The HMI mode may be classified into a maximum guidance mode, an intermediate guidance mode, and a minimum guidance mode. The maximum guidance mode, the intermediate guidance mode, and the minimum guidance mode may respectively correspond to states indicating the occupant's attention level in driving from lower to higher. In addition, the HMI mode may be classified into two or more modes according to various criteria.

The vehicle 10 may provide an autonomous driving function. In this case, the guidance information about the vehicle 10 may include guidance information on the driving situation of the vehicle 10 or a behavior to be performed by the vehicle 10.

Referring to FIG. 1, the vehicle 10 may include some or all of an input device 100, an occupant sensing device 110, an output device 120, a communications device 130, a controller 140, an autonomous driving system 150, and a storage 160. Each of the components may include a device or logic mounted on the vehicle 10. Not all of the blocks shown in FIG. 1 are essential components, and in another embodiment, some blocks included in the vehicle 10 may be added, changed, or deleted.

The components may exchange signals with each other through an internal communications system (not shown). The signals may contain data. The internal communications system may use at least one communications protocol (e.g., CAN, LIN, FlexRay, MOST, and Ethernet).

The HMI mode provision device according to an exemplary embodiment of the present disclosure may include one or more of the device or logic mounted on the vehicle 10. For example, the HMI mode provision device may include the controller 140 and the storage 160. In another embodiment, the function of The HMI mode provision device may be implemented through integration into the autonomous driving system 150.

The input device 100, which is an HMI between the vehicle 10 and an occupant, may be configured to receive an input for setting or changing values for various functions from the occupant. The input device 100 may be implemented as at least one physical button, touch panel, and/or microphone.

The input device 100 may be configured to receive a setting input for an HMI mode from an occupant. For example, the occupant may set one of the maximum guidance mode, the intermediate guidance mode, and the minimum guidance mode as the HMI mode using the input device 100 or may set the HMI mode to be changed on the basis of the occupant's state.

The occupant sensing device 110 may be configured to acquire information about an occupant inside the vehicle 10. Here, the information about the occupant may include a captured image of the occupant, the voice of the occupant, and/or bio-signals (e.g., a heart rate, etc.) of the occupant. The occupant sensing device 110 may be implemented as at least one camera for photographing the inside of the vehicle 10, a microphone for receiving the occupant's voice, and various sensing devices capable of sensing the occupant's bio-signals.

The output device 120, which is an HMI between the vehicle 10 and the occupant, may be configured to provide information about the vehicle 10 to the occupant. The output device 120 may include some or all of a display 122, a sound device 124, and a haptic device 126.

The display 122 may provide the information about the vehicle 10 to the occupant using a graphic user interface (GUI). The display 122 may be implemented as a display disposed in one region, e.g., a seat, of the vehicle 10, an audio video navigation (AVN), a head-up display (HUD) and/or a cluster. The display 122 may be implemented as a touch display or the like through combination with the input device 100.

The sound device 124 may provide the information about the vehicle 10 to the occupant using an auditory user interface (AUI). The sound device 124 may be implemented as a speaker that outputs a voice and/or a notification sound.

The haptic device 126 may provide the information about the vehicle 10 to the occupant using a physical user interface (PUI). The haptic device 126 may be implemented as a vibration module provided in a steering wheel, a seat belt, and/or a seat.

The communications device 130 is configured to communicate with an external device of the vehicle 10. Depending on some exemplary embodiments, the communications device 130 may be configured to communicate with an occupant terminal 12 carried by the occupant in a wired or wireless communication manner. Here, the occupant terminal 12 is a device that is carried by the occupant of the vehicle 10. This may be, for example, a mobile device such as a smartphone, a smartwatch, and a tablet.

The communications device 130 may be configured to transmit, to the occupant terminal 12, an HMI mode corresponding to the occupant's state, guidance information to be provided to the occupant, and/or a signal that causes the occupant terminal 12 to operate in a predetermined manner. For example, the communications device 130 may be configured to transmit, to the occupant terminal, a signal that causes the occupant terminal 12 to generate vibration.

Thus, the vehicle 10 may visually, auditorily and/or tactically interact with the occupant by using at least one of the output device 120 and the occupant terminal 12.

The controller 140 may be configured to perform control and computation related to the provision of the HMI mode in cooperation with at least one of the input device 100, the occupant sensing device 110, the output device 120, the communications device 130, and the storage 160. The controller 140 may be implemented as one or more processors, for example, an electronic control unit (ECU), a micro controller unit (MCU), or other sub-controller mounted on a vehicle.

The controller 140 may be configured to determine the state of the occupant inside the vehicle, determine an HMI mode corresponding to the occupant's state from among a plurality of predefined HMI modes, and provide guidance information to the occupant in a medium-specific output scheme corresponding to the determined HMI mode.

The controller 140 may be configured to determine the state of the occupant on the basis of information about the occupant acquired from the occupant sensing device 110. Here, the state of the occupant may relate to the gaze and/or behavior of the occupant.

The controller 140 may be configured to analyze the occupant's gaze on the basis of the information about the occupant acquired from the occupant sensing device 110. For example, the controller 140 may be configured to determine whether the occupant gazes outside of the vehicle 10, such as a front area or a side area of the vehicle 10, on the basis of a captured image of the occupant.

The controller 140 may be configured to analyze the occupant's behavior pattern on the basis of the information about the occupant acquired from the occupant sensing device 110. For example, the controller 140 may be configured to determine whether the occupant is sleeping, talking, reading a book, and/or watching a movie on the basis of the captured image of the occupant. As another example, the controller 140 may be configured to determine whether the occupant expresses interest in an external situation of the vehicle 10 on the basis of the occupant's voice or the like.

The controller 140 may be configured to determine an HMI mode corresponding to the state of the occupant from among the plurality of HMI modes. The controller 140 may be configured to determine an HMI mode corresponding to the state of the occupant on the basis of the correlation between the occupant's state and the HMI mode.

Table 1 shows an example of the correlation between the occupant's state and the HMI mode.

TABLE 1

| Occupant's State | HMI Mode |
|---|---|
| Continuous External Attention, | Maximum Guidance Mode |
| Expression of Interest | |
| Intermittent External Gaze | Intermediate Guidance Mode |
| No External Attention, | Minimum Guidance Mode |
| Separate Task Execution | |

Referring to Table 1, the correlation between the occupant's state and the HMI mode may be defined based on the degree to which the occupant is interested in the external situation of the vehicle 10.

For example, in response to determining that the occupant expresses interest in the outside, such as continuously gazing outside of the vehicle 10, the controller 140 may be configured to determine the HMI mode as the maximum guidance mode. In response to determining that the occupant intermittently gazes outside of the vehicle 10, the controller 140 may determine the HMI mode as the intermediate guidance mode. Also, in response to determining that the occupant does not gaze outside of the vehicle 10 or performs a task (e.g., sleeping, talking, using a mobile phone, watching media, etc.) for more than a preset time, the controller 140 may determine the HMI mode as the minimum guidance mode.

Depending on some exemplary embodiments, the degree to which the occupant gazes outside of the vehicle 10 may be classified based on the time during which the occupant gazes outside or the number of times the occupant gazes outside within a preset time.

For example, in response to determining that the time during which the occupant gazes outside is greater than or equal to a preset first threshold time, the controller 140 may be configured to determine that the occupant is continuously gazing outside. In response to determining that the time during which the occupant gazes outside is less than the preset first threshold time and is greater than or equal to a preset second threshold time, the controller 140 may be configured to determine that the occupant is intermittently gazing outside. In response to determining that the time during which the occupant gazes outside is less than the second threshold time, the controller 140 may be configured to determine that the occupant does not gaze outside.

As another example, in response to determining that the number of times the occupant gazes outside within a preset threshold time is greater than or equal to a preset first threshold number, the controller 140 may be configured to determine that the occupant is continuously gazing outside. In response to determining that the number of times the occupant gazes outside within the preset threshold time is less than the preset first threshold number and is greater than or equal to a present second threshold number, the controller 140 may be configured to determine that the occupant is intermittently gazing outside. In response to determining that the number of times the occupant gazes outside within the preset threshold time is less than the preset second threshold number, the controller 140 may be configured to determine that the occupant does not gaze outside.

The controller 140 may be configured to provide guidance information to the occupant using the output device 120 and/or the occupant terminal 12.

The controller 140 may be configured to provide guidance information to the occupant by using at least one medium among an AUI, a GUI, and a PUI. The controller 140 may be configured to provide guidance information to the occupant in an output scheme corresponding to an HMI mode for each medium. The controller 140 may be configured to provide guidance information using a target device corresponding to the medium. Here, the target device corresponding to the medium may include the output device 120 and/or the occupant terminal 12. For example, the target device corresponding to the GUI may include the display 122 and/or the occupant terminal 12. The target device corresponding to the AUI may include the sound device 124 and/or the occupant terminal 12. The target device corresponding to the PUI may include the haptic device 126 and/or the occupant terminal 12. The controller 140 may be configured to control the output device 120 to output the guidance information in the output scheme corresponding to the HMI mode. The controller 140 may be configured to transmit, to the occupant terminal 12, an instruction to output the guidance information in the output scheme corresponding to the HMI mode, using the communications device 130.

For each of the plurality of HMI modes, the controller 140 may be configured to determine the medium-specific output scheme corresponding to the HMI mode with reference to a table in which at least one of a medium type, a medium-specific output scheme, and a medium-specific output level to be used to provide the guidance information is mapped to each of the plurality of HMI modes (hereinafter referred to as an HMI map).

Table 2, which is an example of the HMI map, shows a table in which the medium output scheme and the medium type to be used for providing the guidance information are mapped to each of the HMI modes.

TABLE 2

| | GUI | AUI | PUI |
|---|---|---|---|
| Maximum | Stop existing tasks, | Voice guidance | Seat and |
| Guidance | and output guidance | | occupant terminal |
| Mode | information | | vibration |
| Intermediate | Output guidance | Notification | Seat vibration |
| Guidance | information over | sound | |
| Mode | existing tasks | | |
| Minimum | Guidance information | — | |
| Guidance | is output only when | | |
| Mode | route is output | | |

The controller 140 may be configured to determine the type and/or number of media used to provide the guidance information to the occupant on the basis of the HMI mode. For example, in response to determining that the HMI mode is the maximum guidance mode, the controller 140 may be configured to provide the guidance information to the occupant using a GUI, an AUI, and a PUI. In response to determining that the HMI mode is the intermediate guidance mode, the controller 140 may be configured to provide the guidance information to the occupant using a GUI and an AUI. In response to determining that the HMI mode is the minimum guidance mode, the controller 140 may provide the guidance information to the occupant using only a GUI. For example, the controller 140 may provide one among respective levels of guidance information to the occupant, based on a determination of a state/mode among the maximum guidance mode, the intermediate guidance mode, and the minimum guidance mode.

The controller 140 may be configured to determine the output scheme of at least one medium used to provide the guidance information to the occupant on the basis of the HMI mode.

The output scheme of the medium may include whether the target device corresponding to the medium will stop an already performed task. For example, referring to Table 2, in response to the controller 140 determining that the HMI mode is the maximum guidance mode, the display 122 and/or the occupant terminal 12 may stop the previously performed task (e.g., playing a movie) and output the surrounding situation information and driving route of the vehicle 10 in a pop-up form. Meanwhile, in response to the controller 140 determining that the HMI mode is the intermediate guidance mode, the display 122 and/or the occupant terminal 12 may output the surrounding situation information and driving route of the vehicle 10 in a pop-up form while maintaining the previously performed task.

The output scheme of the medium may include a condition in which the target device corresponding to the medium will output the guidance information. For example, referring to Table 2, in response to the controller 140 determining that the HMI mode is the minimum guidance mode, the display 122 and/or the occupant terminal 12 may output the surrounding situation information and driving route of the vehicle 10 only when outputting the driving route of the vehicle 10 and may not output the surrounding situation information and driving route when performing other tasks. Meanwhile, in response to the controller 140 determining that the HMI mode is the maximum guidance mode or the intermediate guidance mode, the display 122 and/or the occupant terminal 12 may output the surrounding situation information and driving route of the vehicle 10 even when performing other tasks.

The output scheme of the medium may include the amount of information included in the guidance information provided by the medium. For example, referring to Table 2, in response to the controller 140 determining that the HMI mode is the maximum guidance mode, the sound device 124 and/or the occupant terminal 12 may provide detailed voice-based guidance information. On the other hand, in response to the controller 140 determining that the HMI mode is the intermediate guidance mode, the sound device 124 and/or the occupant terminal 12 may provide brief notification-sound-based guidance information.

The output scheme of the medium may include the number of target devices that provide guidance information using the medium. For example, referring to Table 2, the occupant terminal 12 and the haptic device 126 mounted on a seat may generate vibration in response to the controller 140 determining that the HMI mode is the maximum guidance mode, and only the haptic device 126 may generate vibration in response to the controller 140 determining that the HMI module is the intermediate guidance mode.

Table 3, which is another example of the HMI map, shows a table in which the medium output level and the medium type to be used for providing the guidance information are mapped to each of the HMI modes. Meanwhile, Table 3 shows the output level of each medium as one of level 1, level 2, and level 3, but the present disclosure is not limited thereto. The number of output levels may vary depending on the number of HMI modes.

TABLE 3

| | GUI | AUI | PUI |
|---|---|---|---|
| Maximum | Level 3 | Level 2 | Level 1 |
| Guidance | | | |
| Mode | | | |
| Intermediate | Level 2 | Level 1 | — |
| Guidance | | | |
| Mode | | | |
| Minimum | Level 1 | — | — |
| Guidance | | | |
| Mode | | | |

The controller 140 may be configured to determine an output scheme corresponding to the HMI mode on the basis of a predefined correlation between a medium-specific output level and a medium-specific output scheme. As an example, as the output level of the medium decreases, the controller 140 may be configured to determine the output scheme of the medium such that the target device corresponding to the medium restrictively provide the guidance information only when a preset condition is satisfied. As another example, as the output level of the medium increases, the controller 140 may be configured to determine the output scheme of the medium such that the amount of information contained in the guidance information increases. As another example, as the output level of the medium increases, the controller 140 may be configured to determine the output scheme of the medium such that the number of target devices that provide the guidance information using the medium increases.

The controller 140 may be configured to determine a medium-specific output scheme corresponding to the HMI mode by using an HMI map corresponding to an event occurring in the vehicle 10 among one or more HMI maps. In other words, the controller 140 may be configured to determine the medium-specific output scheme corresponding to the HMI mode with reference to a different HMI map for each event. Here, the event may refer to a situation in which guidance information needs to be provided, such as joining a highway, cutting in front of a vehicle ahead, turning left, changing lanes, and crossing an intersection.

For example, in response to determining that a highway joining event occurs while the vehicle 10 is traveling, the controller 140 may be configured to determine a medium-specific output scheme with reference to an HMI map (hereinafter referred to as a first HMI map) corresponding to the highway joining event among one or more prestored HMI maps. As another example, in response to determining that an event occurs in which another vehicle cuts in front of the vehicle 10, the controller 140 may be configured to determine a medium-specific output scheme with reference to an HMI map (hereinafter referred to as a second HMI map) corresponding to the vehicle cut-in event among one or more prestored HMI maps.

The controller 140 may be configured to receive event information from the autonomous driving system 150 mounted on the vehicle 10. The autonomous driving system 150 may be configured to generate a control signal for driving the vehicle 10 on the basis of information acquired from various devices mounted on the vehicle and may provide an autonomous driving function of the vehicle 10. Depending on some exemplary embodiments, the autonomous driving system 150 may include one or more processors. Depending on other exemplary embodiments, when implemented in software, the autonomous driving system 150 may be a sub-concept of the controller 140.

Depending on some exemplary embodiments, the controller 140 may be configured to detect, or directly detect, an event occurring while the vehicle 10 is traveling on the basis of the driving route of the vehicle 10, an image acquired from a camera (not shown) that captures the outside of the vehicle, etc.

Meanwhile, the HMI maps as shown in Table 2 and/or Table 3 may be preset by manufacturers or occupants. For example, an occupant may set an HMI map using the input device 100. As another example, the occupant may set the HMI map using the occupant terminal 12, and the controller 140 may receive the HMI map from the occupant terminal 12 using the communications device 130.

In response to determining that a plurality of occupants are present in the vehicle 10, the controller 140 may be configured to provide guidance information to the occupants in a medium-specific output scheme corresponding to a preset HMI mode or provide guidance information to the occupants in a medium-specific output scheme corresponding to an HMI mode determined based on the state of a reference occupant among the plurality of occupants. Here, the reference occupant may be a caller who has called the vehicle 10 or an occupant who is seated at a predefined reference position.

In an example, the controller 140 may be configured to determine the position of the reference occupant from among a plurality of positions (e.g., a driver's seat, a passenger's seat, and a back seat behind a driver's seat) in the vehicle 10 and may be configured to determine the state of the reference occupant on the basis of occupant information acquired at the corresponding position.

In another example, the controller 140 may be configured to guide the reference occupant to a predefined reference position and determine whether the reference position is occupied. In response to determining that the reference position is occupied, the controller 140 may be configured to determine the state of the reference occupant on the basis of occupant information acquired at the reference position. On the other hand, in response to determining that the reference position is not occupied, the controller 140 may provide guidance information in a medium-specific output scheme corresponding to a preset HMI mode.

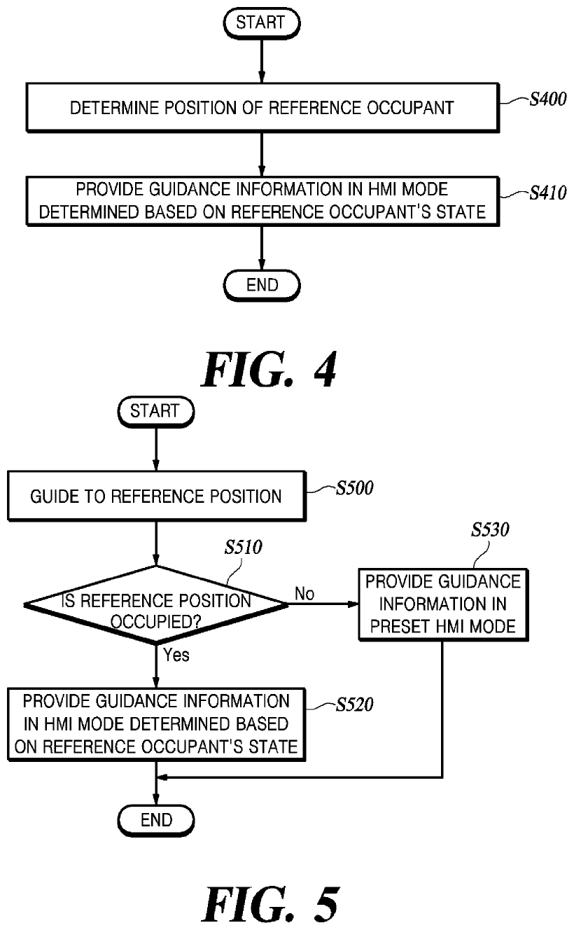

A detailed method of providing an HMI mode to a plurality of occupants will be described below with reference to FIGS. 4 to 6.

The storage 160 may be configured to store various programs and data for providing the HMI mode according to an exemplary embodiment of the present disclosure. For example, the storage 160 may be configured to store a program for the controller 140 to provide the HMI mode. When the program is executed by the controller 140, the controller may be configured to perform the functions/operations described in the present disclosure and/or to cause other components to perform the respective functions/operations. The storage 160 may be configured to store a correlation between the occupant's state and the HMI mode. The storage 160 may be configured to store a criterion (e.g., a threshold time or a threshold number of times) for classifying the degree to which the occupant gazes outside of the vehicle 10. The storage 160 may be configured to store one or more HMI maps in which a medium-specific output level or a medium-specific output scheme is mapped to each of the plurality of HMI modes.

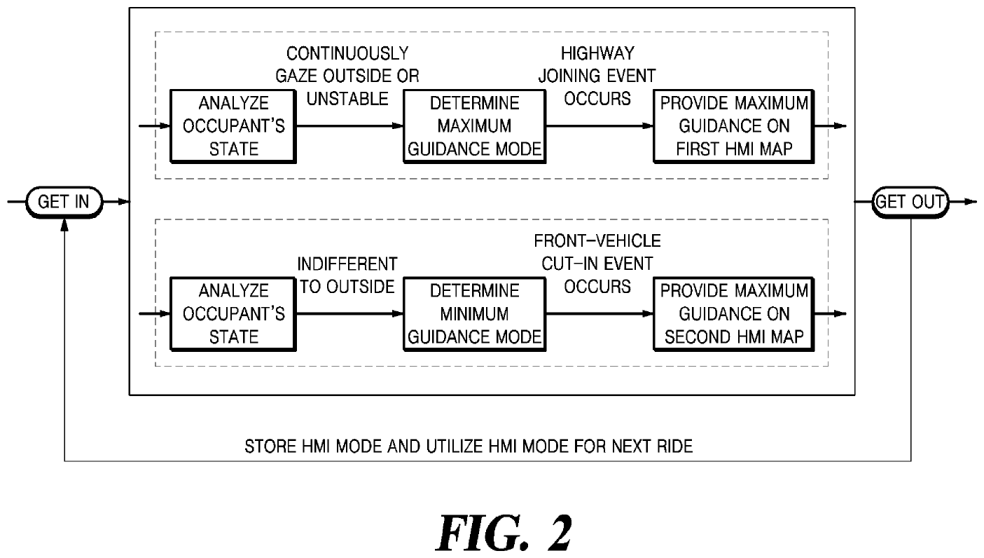

FIG. 2 is a diagram illustrating an example of an operation in which an HMI mode provision device determines an HMI mode on the basis of an occupant's state according to an exemplary embodiment of the present disclosure.

In response to determining that the occupant gets in the vehicle 10, the HMI mode provision device may be configured to start analyzing the occupant's gaze and/or behavior pattern. In response to determining that the occupant is anxious and constantly stares outside, the HMI mode provision device may be configured to determine the maximum guidance mode as the HMI mode.

In response to determining that a highway joining event occurs while the vehicle 10 travels in the maximum guidance mode, the HMI mode provision device may be configured to provide guidance information to the occupant in an output scheme which is mapped to the maximum guidance mode on the first HMI map corresponding to the highway joining event. For example, the HMI mode provision device may be configured to provide the guidance information using a GUI, an AUI, and a PUI on the basis of information mapped to the maximum guidance mode on the first HMI map. Also, in providing guidance information using a GUI, the HMI mode provision device may be configured to perform control such that the display 122 stops a previously performed task (e.g., playing a movie) and outputs the surrounding situation information and driving route of the vehicle 10 in a pop-up form. In providing the guidance information using an AUI, the HMI mode provision device may be configured to perform control such that the sound device 124 outputs voice-based guidance information “We will join the highway.” In providing the guidance information using a PUI, the HMI mode provision device may be configured to perform control such that the haptic device 126 and the occupant terminal 12 generate vibration.

In response to determining that the occupant is indifferent to an external situation, such as not staring outside, the HMI mode provision device may be configured to change the HMI mode from the maximum guidance mode to the minimum guidance mode.

In response to determining that a front-vehicle cut-in event occurs while the vehicle 10 travels in the minimum guidance mode, the HMI mode provision device may be configured to provide guidance information to the occupant in an output scheme which is mapped to the minimum guidance mode on the second HMI map corresponding to the front-vehicle cut-in event. For example, the HMI mode provision device may be configured to provide the guidance information using only a GUI among a GUI, an AUI, and a PUI on the basis of information mapped to the minimum guidance mode on the second HMI map. Also, in providing the guidance information using a GUI, the HMI mode provision device may be configured to perform control such that the surrounding situation information and driving route of the vehicle 10 are output only when the display 122 outputs the driving route of the vehicle 10 and such that the surrounding situation information and the driving route are not output when the display 122 outputs other tasks.

When the occupant gets out of the vehicle 10, the HMI mode provision device may be configured to store HMI mode information about the occupant and may be configured to utilize the HMI mode information when the occupant gets in again in the future. Here, the HMI mode information about the occupant may include an HMI mode that was being provided to the occupant before the occupant gets out, a change history of the HMI mode and/or an occupant state analysis result. The HMI mode provision device may be configured to store the HMI mode information in the storage 160 and/or the occupant terminal 12, but the present disclosure is not limited thereto. For example, the HMI mode information device may store the HMI mode information in a separate external server (not shown).

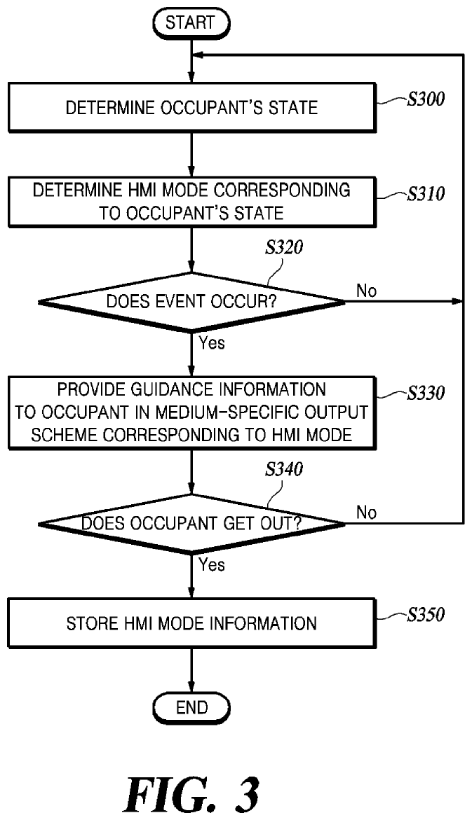

FIG. 3 is a flowchart illustrating an HMI mode provision method according to an exemplary embodiment of the present disclosure.

The method shown in FIG. 3 may be performed by the controller 140 or the HMI mode provision device that has been described above in FIGS. 1 and 2, and thus a redundant description thereof will be omitted.

The HMI mode provision device determines an occupant's state on the basis of occupant information acquired from an occupant sensing device 110 (S300).

The HMI mode provision device determines an HMI mode corresponding to the occupant's state among a plurality of predefined HMI modes (S310). The HMI mode provision device may determine an HMI mode on the basis of the degree to which the occupant is interested in the external situation of a vehicle 10.

The HMI mode provision device checks whether an event requiring the provision of guidance information has occurred (S320). For example, the HMI mode provision device may receive event information from an autonomous driving system 150 mounted on the vehicle 10 or may directly, or directly detect, an event occurring while the vehicle 10 is traveling on the basis of the driving route of the vehicle 10 and an image acquired from a camera (not shown) that captures the outside of the vehicle 10.

In response to determining that an event occurs, the HMI mode provision device provides guidance information to the occupant in a medium-specific output scheme corresponding to the HMI mode (S330). The HMI mode provision device may determine at least one medium among a GUI, an AUI, and a PUI and at least one medium output scheme to be used to provide the guidance information to the occupant. Here, the medium output scheme may include one or more of whether a target device corresponding to the medium stops an already performed task, a condition for the target device corresponding to the medium to output guidance information, the amount of information contained in guidance information, and the number of target devices corresponding to a medium that is to provide guidance information.

The HMI mode provision device may determine the medium-specific output scheme with reference to an HMI map in which at least one of a medium type, a medium output level, and an output scheme to be used to provide guidance information is mapped to each of the plurality HMI mode. The HMI mode provision device may determine the medium-specific output scheme with reference to an HMI map corresponding to an event occurring in the vehicle among one or more prestored HMI maps.

The HMI mode provision device may change the output level or output scheme of the guidance information according to the occupant's state by repeating operations S300 to S330 until the occupant gets out.

The HMI mode provision device stores HMI mode information about the occupant in response to determining that the occupant gets out of the vehicle 10 (S350). The HMI mode information may be used to initially determine the HMI mode when the occupant gets in again.

FIGS. 4 to 6 are flowcharts illustrating an example of a method of an HMI mode provision device providing an HMI mode to multiple occupants according to an exemplary embodiment of the present disclosure.

FIG. 4 illustrates an example in which the HMI mode provision device provides an HMI mode to a plurality of occupants when an occupant sensing device 110 can acquire information about the occupants at all positions in the vehicle 10.

The HMI mode provision device determines the position of a reference occupant (hereinafter referred to as a first reference position) among a plurality of positions (S400). The plurality of positions may be classified into a driver's seat, a passenger's seat, a seat behind a driver's seat, and the like, but the present disclosure is not limited thereto. For example, the plurality of positions may be distinguished based on an identification number assigned in advance. The reference occupant may be a caller who calls the vehicle 10, but the present disclosure is not limited thereto.

Depending on some exemplary embodiments, the HMI mode provision device may determine a first reference position on the basis of occupant information acquired from the occupant sensing device 110. For example, the HMI mode provision device may recognize the occupant's biometric information and determine the first reference occupied position. Here, the recognition of the occupant's biometric information may include face recognition, voice recognition, fingerprint recognition, or iris recognition. However, the present disclosure is not limited thereto, and any information capable of identifying an occupant may be included. In response to determining that an occupant's biometric information at a specific position is matched with preset reference information, the HMI mode provision device may determine the corresponding position as the first reference position. To this end, the HMI mode provision device may prestore reference information or acquire the reference information from an occupant terminal 12 carried by the reference occupant when the vehicle 10 is called.

Depending on some exemplary embodiments, the HMI mode provision device may receive information about the first reference position from the occupant using an input device 100 or may acquire the position of the occupant terminal 12 carried by the reference occupant as the first reference occupied position.

The HMI mode provision device determines the reference occupant's state on the basis of occupant information acquired at the first reference occupant position and provides guidance information in an HMI mode determined based on the reference occupant's state. Operation S410 of FIG. 4 may be identical to or correspond to operations S300 to S330 of FIG. 3.

FIG. 5 illustrates an example in which the HMI mode provision device provides an HMI mode to a plurality of occupants when an occupant sensing device 110 can acquire only information about an occupant that is seated in a specific position (hereinafter referred to as a second reference position) in the vehicle 10.

The HMI mode provision device guides occupants to a second reference position before the occupants get in the vehicle 10 (S500). For example, HMI mode provision device may guide the occupants to the second reference position by transmitting information about the second reference position to the occupant terminal 12 that has called the vehicle 10 or outputting information about the second reference position using an output device 120 of the vehicle 10.

The HMI mode provision device determines whether the second reference position is occupied (S510). For example, the HMI mode provision device may determine whether the second reference position is occupied on the basis of whether the occupant is detected in an image acquired from the occupant sensing device 110, but the present disclosure is not limited thereto. For example, the HMI mode provision device may determine whether the second reference position is occupied on the basis of whether the occupant's bio-signal is acquired from the occupant sensing device 110.

Depending on some exemplary embodiments, the HMI mode provision device may determine whether the second reference position is occupied by an occupant who satisfies a preset condition. For example, the HMI mode provision device may determine whether the occupant seated at the second reference position is a caller who calls the vehicle 10 or whether the occupant seated at the second reference position is an adult.

In response to determining that the second reference position is occupied, the HMI mode provision device determines the reference occupant's state on the basis of occupant information acquired at the second reference position and provides guidance information in an HMI mode determined based on the reference occupant's state (S520). Operation S520 of FIG. 5 may be identical to or correspond to operations S300 to S330 of FIG. 3.

In response to determining that the second reference position is not occupied, the HMI mode provision device provides guidance information in a medium-specific output scheme corresponding to a preset HMI mode (S530). For example, the HMI mode provision device may provide guidance information in an output scheme which is mapped to the intermediate guidance mode in a prestored HMI map.

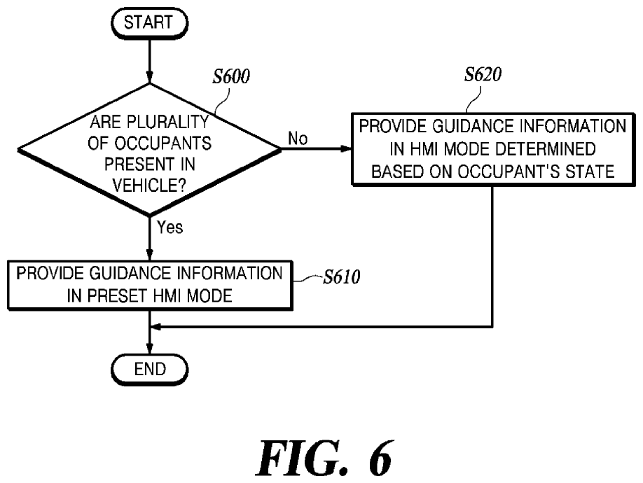

FIG. 6 illustrates an example in which an HMI mode provision device provides a preset HMI mode to a plurality of occupants when the plurality of occupants is present in a vehicle 10.

The HMI mode provision device determines whether a plurality of occupants are present in a vehicle (S600).

In response to determining that a plurality of occupants are present in a vehicle, the HMI mode provision device provides guidance information to the occupants in a medium-specific output scheme corresponding to a preset HMI mode (S610). For example, the HMI mode provision device may provide guidance information to the occupants in an output scheme which is mapped to the intermediate guidance mode in a prestored HMI map.

In response to determining that one occupant is present in a vehicle, the HMI mode provision device provides guidance information in an HMI mode determined based on the occupants' state (S620). Operation S620 of FIG. 6 may be identical to or correspond to operations S300 to S330 of FIG. 3.

Although it is described in FIGS. 3 to 6 that the operations are sequentially executed, this is merely illustrative of the technical spirit of an exemplary embodiment of the present disclosure. In other words, those skilled in the art to which an exemplary embodiment of the present disclosure pertains can make various modifications and changes by changing the orders of operations described in FIGS. 3 to 6 or executing one or more of the operations in parallel within the range that does not deviate from the essential characteristics of an exemplary embodiment of the present disclosure, and thus FIGS. 3 to 6 are not limited to chronological order.

Various implementations of the systems and techniques described herein may include digital electronic circuits, integrated circuits, field-programmable gate arrays (FPGAs), application-specific integrated circuits (ASICs), computer hardware, firmware, software, and/or a combination thereof. These various implementations may include an implementation in one or more computer programs executable on a programmable system. The programmable system includes at least one programmable processor (which may be a special-purpose processor or a general-purpose processor) combined to receive and transmit data and instructions from and to a storage system, at least one input device, and at least one output device. Computer programs (also known as programs, software, software applications or code) include instructions for a programmable processor and are stored on a computer-readable recording medium.

The computer-readable recording medium includes any type of recording apparatus in which data readable by a computer system is stored. Such a computer-readable recording medium may be a non-volatile or non-transitory medium such as ROM, CD-ROM, magnetic tape, floppy disk, memory card, hard disk, magneto-optical disk, and storage device and may further include a transitory medium such as a data transmission medium. Also, the computer-readable recording medium may be distributed over network-coupled computer systems, and computer-readable code may be stored and executed in a distributed fashion.

Various implementations of the systems and techniques described herein may be made by a programmable computer. Here, the computer includes a programmable processor, a data storage system (including volatile memory, non-volatile memory, other types of storage systems, or combinations thereof) and at least one communication interface. For example, a programmable computer may be one of a server, a network appliance, a set-top box, an embedded device, a computer expansion module, a personal computer, a laptop, a personal data assistant (PDA), a cloud computing system, or a mobile device.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand the scope of the claimed invention is not to be limited by the above explicitly described embodiments but by the claims and equivalents thereof.

What is claimed is:

1. A method, performed by a device of vehicle, for providing a human-machine interface (HMI) mode, the method comprising:
determining an occupant's state;
determining an HMI mode corresponding to the occupant's state among a plurality of predefined HMI modes; and
providing guidance information to the occupant in a medium-specific output scheme corresponding to the determined HMI mode.

2. The method of claim 1, wherein the HMI mode is determined based on a degree to which the occupant is interested in an external situation of the vehicle.

3. The method of claim 1, wherein the plurality of HMI modes include one or more of a maximum guidance mode, an intermediate guidance mode, and a minimum guidance mode,
wherein the maximum guidance mode corresponds to a state in which the occupant continuously gazes outside of the vehicle,
wherein the intermediate guidance mode corresponds to a state in which the occupant intermittently gazes outside of the vehicle, and
wherein the minimum guidance mode corresponds to a state in which the occupant does not gaze outside of the vehicle or performs a task for a preset period of time or longer.

4. The method of claim 1, wherein the plurality of HMI modes include one or more of a maximum guidance mode, an intermediate guidance mode, and a minimum guidance mode,
wherein the maximum guidance mode, the intermediate guidance mode, and the minimum guidance mode respectively correspond to states indicating the occupant's attention level in driving from lower to higher.

5. The method of claim 1, wherein the providing the guidance information comprises:
determining at least one medium to be used to provide guide information to the occupant among a graphical user interface (GUI), an auditory user interface (AUI), and a physical user interface (PUI) and an output scheme of the at least one medium.

6. The method of claim 5, wherein the output scheme of the medium is determined based on one or more tables in which a medium-specific output scheme or a medium-specific output level is mapped to each of the plurality of HMI modes.

7. The method of claim 6, wherein the output scheme of the medium is determined based on a table corresponding to an event that has occurred in the vehicle among the one or more tables.

8. The method of claim 5, wherein the output scheme of the medium includes one or more of whether to stop a task that has already been performed by a target device corresponding to the medium, a condition for the target device corresponding to the medium to output guidance information, an amount of information contained in the guidance information, and the number of the target device corresponding to the medium that is to provide the guidance information.

9. The method of claim 1, further comprising:
determining a first reference position, which is a position occupied by a reference occupant, among a plurality of positions in the vehicle, and
wherein the determining the occupant's state comprises:
determining the occupant's state on the basis of occupant information acquired at the first reference position.

10. The method of claim 1, further comprising:
guiding the occupant to a predefined second reference position; and
determining whether the second reference position is occupied, and
wherein the determining the occupant's state comprises:
determining the occupant's state on the basis of occupant information acquired at the second reference position.

11. The method of claim 1, further comprising:
providing guidance information to the occupant in a medium-specific output scheme corresponding to a preset HMI mode in response to determining that a plurality of occupants are present in the vehicle or that a predefined second reference position is not occupied.

12. A device for providing a human-machine interface (HMI) mode, the device comprising:
a controller configured to determine an occupant's state in a vehicle, determine an HMI mode corresponding to the occupant's state among a plurality of predefined HMI modes, and provide guidance information to the occupant in a medium-specific output scheme corresponding to the determined HMI mode.

13. The device of claim 12, wherein the controller is configured to:
determine the HMI mode corresponding to the occupant's state on the basis of a degree to which the occupant is interested in an external situation of the vehicle.

14. The device of claim 12, wherein the controller is configured to:
determine at least one medium to be used to provide guide information to the occupant among a graphical user interface (GUI), an auditory user interface (AUI), and a physical user interface (PUI) and an output scheme of the at least one medium.

15. The device of claim 12, further comprising:
a storage configured to store one or more tables in which a medium-specific output scheme or a medium-specific output level is mapped to each of the plurality of HMI modes.

16. The device of claim 15, wherein the controller is configured to:
determine a medium-specific output scheme corresponding to the HMI mode using a table corresponding to an event occurring in the vehicle among one or more tables stored in the storage.

17. The device of claim 12, wherein the plurality of HMI modes include one or more of a maximum guidance mode, an intermediate guidance mode, and a minimum guidance mode,
wherein the maximum guidance mode corresponds to a state in which the occupant continuously gazes outside of the vehicle,
wherein the intermediate guidance mode corresponds to a state in which the occupant intermittently gazes outside of the vehicle, and
wherein the minimum guidance mode corresponds to a state in which the occupant does not gaze outside of the vehicle or not perform a task for a preset period of time or longer.

18. The device of claim 12, wherein the plurality of HMI modes include one or more of a maximum guidance mode, an intermediate guidance mode, and a minimum guidance mode,
wherein the maximum guidance mode, the intermediate guidance mode, and the minimum guidance mode respectively correspond to states indicating the occupant's attention level in driving from lower to higher.

19. A vehicle comprising the device of claim 12.
